(19) United States
(12) Patent Application Publication
(10) Pub. No.: US 2006/0125232 A1
(43) Pub. Date: Jun. 15, 2006

(54) Spray fitting for a tower pertaining to an installation for treating a gas flow with a liquid

(76) Inventors: Werner Braun, Margetshochheim (DE); Wolfram Engelking, Tannhauserstrasse (DE); Uwe-Paul Schadow, Gummersbach (DE)

Correspondence Address: ROBERT W. BECKER & ASSOCIATES, 707 HIGHWAY 66 EAST, SUITE B, TIJERAS, NM, 87059, US

(21) Appl. No.: 10/540,598

(22) PCT Filed: Dec. 22, 2003
(86) PCT No.: PCT/EP03/14746

§ 371 Date: Jun. 23, 2005

(51) Int. Cl. F16L 33/00; F16L 47/00; F16L 49/00

(52) U.S. Cl. 285/245; 285/246; 285/247

(57) ABSTRACT

A spray fitting for a tower of an installation for treatment of a gas flow with a liquid, especially for a flue-gas purification installation, includes a main pipe extending essentially horizontally through the center of the tower, a plurality of distributing pipes which extend from both sides of the main pipe essentially in one plane, and a plurality of spray nozzles associated with each distributing pipe, whereby at least one pump for feeding the treatment liquid into the main pipe is associated with the fitting.

The present invention relates to a spray fitting for a tower of an installation for treatment of a gas flow with a liquid, especially for a flue-gas purification installation, with a main pipe extending essentially horizontally through the center of the tower, a plurality of distributing pipes which extend towards both sides of the main pipe essentially in one plane, and a plurality of spray nozzles associated with each distributing pipe, whereby at least one pump for feeding the treatment liquid into the main pipe is associated with the fitting.

With a flue-gas wash with a calcium-containing suspension for separation of SO2 and other components, large amounts of the suspension must be distributed over the cross section of the washing tower. In this regard, spray fittings with a primary pipe and distributing pipes are provided in the washer in at least two planes lying over one another; each pipe is associated with at least one pump. With only one pump and its breakdown, the spraying plane breaks down. By supplying the spray fitting with two pumps, a complete spraying plane no longer remains functional upon the breakdown of one pump with regard to distribution, pressure, and the specific surface of the drops produced.

It is therefore an object of the present invention to produce a spray fitting, in which the volumes of treatment liquid supplied by two pumps can be supplied independently from one another in one spraying plane.

This object is solved in that the main pipe is formed as two channels and each channel is impinged with treatment liquid by at least one pump and on each side of the main pipe, one part of the distributing pipes is connected with one channel and the other part of the distributing pipes is connected with the other channel.

With the two-channel structure of the main pipe and the connection of the distributing pipes to both sides of the main pipe to one or the other channel, the supply volume of the two pumps can be supplied independently from one another in a height coordinate. Thus, in one spraying plane, two completely separate distributing systems exist. The space requirements of a typically used assembly of two overlying spraying planes at one height in the treatment tower is reduced to the space requirements of one spraying plane. At the same time, reduction of the power requirements of the installation occurs.

If multiple spraying planes are required because of the amount of the gas volume to be treated, with the structure of the present invention, the spray fittings in two overlying spraying planes, upon breakdown of a pump in one plane, can assume the function of the other overlying or underlying spraying plane with regard to its distribution. In this manner, the planes arranged at different heights form a completely functional suspension plane. Gas breakthroughs are thereby avoided.

The two-channel structure of the main pipe is achieved, in a preferred manner, in that a sheet in the main pipe extends essentially from the low point at one end of the main pipe essentially to the high point on the other end of the main pipe, whereby the supply of the treatment liquid takes place at opposing ends of the channels.

With this embodiment, the distributing pipes can be connected in a simple manner—if necessary, via bent intermediate pieces—through the pipe wall to the channels.

A further embodiment of the two-channel structure is achieved in that in the main pipe, an auxiliary pipe is arranged and the annular chamber formed between the main pipe and the auxiliary pipe form one channel and the interior of the auxiliary pipe forms the other channel, whereby the supply of treatment liquid takes place at opposite ends or at adjacent ends of the channels.

In order to obtain in the simplest manner supply systems with the most uniform distribution of the liquid as possible, it is provided that the distributing pipes are alternatingly connected on each side of the main pipe with one channel or the other channel. Thus, a distributing pipe of one system always lies next to a distributing pipe of the other system. As with the known fittings, the length of the lateral distributing pipes is adapted to the cross sectional geometry of the tower or the washer.

In addition, for purposes of uniformity of the spraying pressure over the length of the distributing pipes, it is advisable that the cross section of the distributing pipes is stepped toward the free ends or decreases continuously.

It is preferred that the stepping takes place such that the distributing pipe has a flat side and an oppositely disposed stepped side.

For the arrangement of the distributing pipes in the spray fitting, it is preferred that the distributing pipes are arranged with their flat sides as the upper sides. Then, in maintenance procedures, wood planks or the like can be placed on the distributing pipes, which make possible a safe monitoring of the spray fitting without steps or ledges.

The distribution of the nozzles on the distributing pipes is selected such that the spacing of adjacent nozzles supported by the distributing pipes is the same within the spraying plane in all directions. An optimal surface allocation is then also achieved even with the loss of half of the suspension distribution plane. Large-surface breakthroughs of the gases to be treated through the plane are avoided.

The nozzle arrangement on the distributing pipes can be a counter flow sprinkling, a direct current sprinkling, or a direct/counter flow sprinkling.

The invention also relates to a tower of a gas treatment installation which is equipped with at least one spray fitting of at least one of claims 1 through 8.

The invention will now be explained in greater detail with the aid of the accompanying drawings, in which:

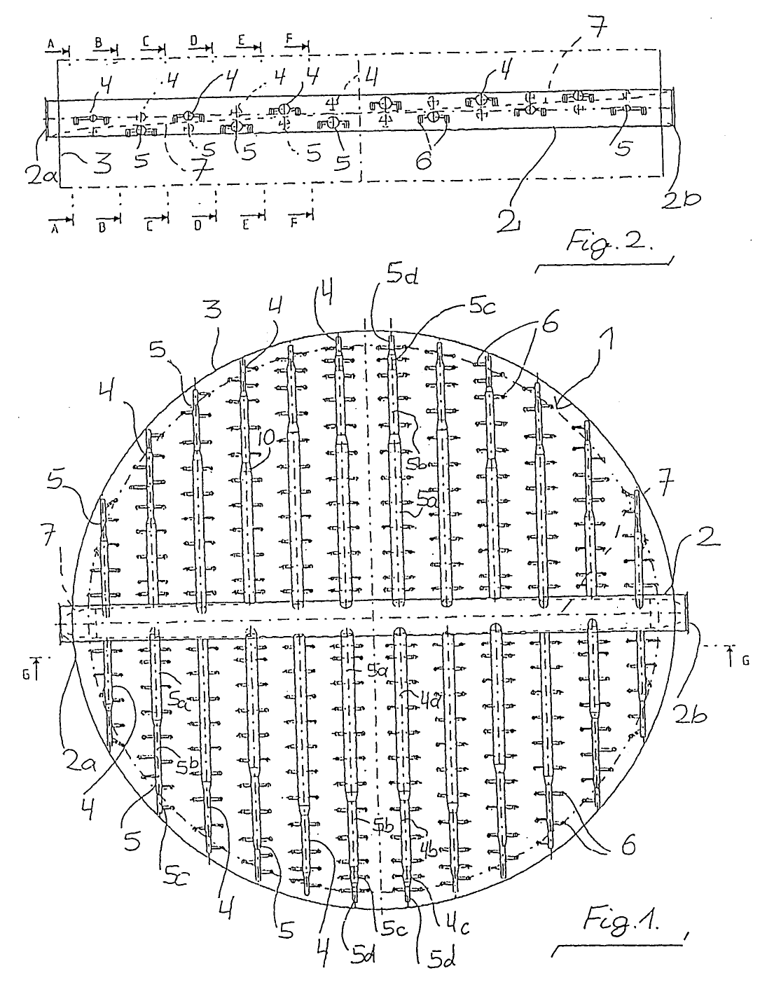

FIG. 1 shows a view of one embodiment of the spray fitting of the present invention;

FIG. 2 shows a side view of the spray fitting of FIG. 2 or a partial section along line G-G in FIG. 1;

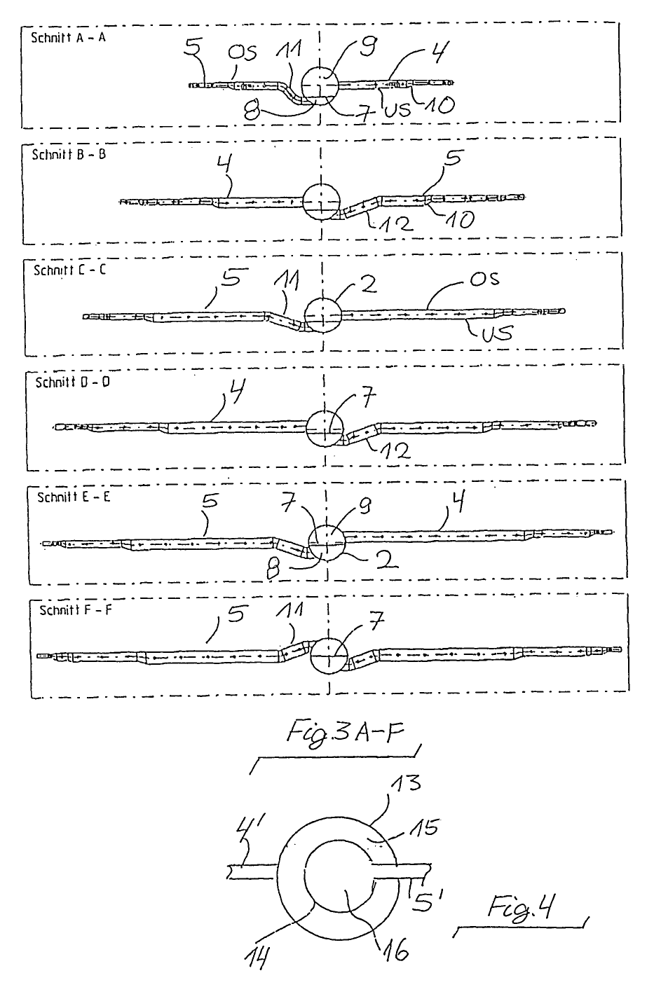

FIGS. 3A-F shows a vertical side view of the distributing pipes or a vertical section through the main pipe with the spray fitting of FIGS. 1 and 2 along lines A-A, B-B, C-C, D-D, E-E, and F-F in FIG. 2; and

FIG. 4 shows a partial vertical section through the main pipe of a further embodiment of the spray fitting of the present invention.

As shown in FIG. 1, the spray fitting 1 has a main pipe 2, both ends 2a and 2b of which penetrate the wall 3 of a washing tower, which has a circular cross section. The pipe extends horizontally and through the center of the washing tower.

On both sides of the main pipe 2, distributing pipes 4 and 5 extend perpendicular to the main pipe 2 and parallel to one another. The length of the distributing pipes is selected such that they end, respectively, near the wall of the washer. On the distributing pipes 4 and 5, a plurality of nozzles 6 is arranged in pairs opposite one another. In the end regions of the distributing pipes, single nozzles 6′ are also individually arranged. The arrangement and distribution of the nozzles is selected such that a uniform surface allocation over the spraying plane defined by the main pipe and the distributing pipes is achieved.

As shown in FIGS. 1, 2, and 3, a sheet 7 extends in the main pipe 2 from the low point of the pipe in the region of the pipe end 2a (left pipe end in FIG. 2) to the high point of the pipe in the region of the pipe end 2b (right pipe end in FIG. 2). As can be seen in FIGS. 1-2, the sheet is inclined on its ends relative to the pipe angle and thereby is formed to be sightly tongue-like. On the ends, respectively, a further angle is selected so that the connecting supports do not extend too far outwardly. As can be seen from FIGS. 3A-3F, the respective section lines of the inclined sheet remain horizontal.

Beneath the sheet 7, a channel 8 is defined and above the sheet, a channel 9 is defined. The channel 8 opens to the pipe end 2b and reduces its cross section toward the pipe end 2a, where it is closed. The channel 9 opens to the pipe end 2a and reduces its cross section toward the pipe end 2b, where it is closed.

The distributing pipes 4 are connected with the channel 9 and the distributing pipes 5 are connected with the channel 8, so that the distributing pipes 4 provided on both sides of the main pipe 6 form a first spraying system with the channel 9 and the distributing pipes 5 form a second spraying system with the channel 8, whereby the first spraying system is supplied from the end 2a of the main pipe with treatment liquid, while the other spraying system is supplied from the pipe end 2b.

As shown in FIGS. 1 and 3, the distributing pipes 4 and 5 are stepped in their diameter at least twice toward their closed ends via conical transition pieces 10. Thus, the pipes 4 and 5 shown in FIGS. 3B-3F, according to their lengths, have two, three, or four sections 4a, 4b, 4c, 4d, or 5a, 5b, 5c, 5d, and both ends 2a or 2b of the distributing pipes adjacent to the main pipe have two sections and the central, longest distributing pipe has four sections. The steps lie such that the pipe has a flat (that is straight) upper sides OS and a stepped underside US. The arrangement is selected such that the upper side OS of all distributing pipes 4 and 5 lie in one plane, which for example can accommodate wood planks during maintenance.

As can be seen form FIGS. 3A through 3F, the individual distributing pipes are connected via curved connection pieces 10 and 12 to the main pipe. As shown in FIGS. 2 and 3A-3F, the connection points for the distributing pipes 4 to the pipe 2 lie on both sides of the main pipe 2 respectively over the sheet 7, while the connection points for the distributing pipes 5 lie on both sides of the main pipe under the sheet. The height position of the connection points of the oppositely disposed distributing pipes 4, 5 arranged in pairs on the main pipe increase from one end 2a to the other end 2b of the main pipe 2 corresponding to the slant of the sheet 7.

With the embodiment shown in FIG. 4, an auxiliary pipe 14 is disposed concentrically in a main pipe 13. The annular space between the two pipes defines a first channel 15 and the interior of the auxiliary pipe forms a second channel 16. Alternatingly disposed distributing pipes 4′ and 5′ are connected with the channel 15 or channel 16 at the same height. The treatment liquid is supplied at one or both ends of the annular chamber 15 or at one or both ends of the auxiliary pipe 14. Also here, two completely independent distribution systems are provided. The connection of the distributing pipes 5′ to the channel 16 through the wall of the main pipe 13, however, is not as simple as that of the embodiment shown in FIGS. 1-3.

The problems of independent spraying systems result not only with flue-gas cleaning, but also with the washing of exhaust or product gases in chemical processes.

### REFERENCE NUMERAL LIST

1 Spray Fitting
2 Main Pipe
2a,2b Ends of the Main Pipe
3 Wall of a Washing Tower
4,4′ Distributing Pipes
4a, 4b, 4c, 4d Distributing Pipe Sections
5,5′ Distributing Pipes
5a, 5b, 5c, 5d Distributing Pipe Sections
6, 6′ Nozzzles
7 Sheet
8 Channel
9 Channel
10 Transition Pieces
11 Connecting Pieces
12 Connecting Pieces
13 Main Pipe
14 Auxiliary Pipe
15 Channel
16 Channel
Upper side of the main pipe
Underside of the main pipe

1-9. (canceled)

10. A spray fitting for a tower of an installation for treating a gas flow with a liquid, comprising:
a main pipe extending essentially horizontally through a center of the tower, wherein the main pipe is formed with two channels;
a plurality of distributing pipes extending from two sides of the main pipe essentially in one plane; and
a plurality of spray nozzles associated with each distributing pipe, whereby at least one pump for feeding treatment liquid into the main pipe is associated with the fitting, wherein each of said channels can be supplied via at least one pump with treatment liquid, and wherein on each side of the main pipe, a first part of the distributing pipes is connected with one of the channels and second part of the distributing pipes is connected with the other channel.

11. The spray fitting of claim 10, further comprising a sheet disposed in the main pipe, wherein said sheet extends essentially from a low point at one end of the main pipe essentially to a topmost point at an opposite end of the main pipe, and wherein a supply of the treatment liquid takes place at opposite ends of the channels.

12. The pray fitting of claim 10, wherein an auxiliary pipe is disposed in the main pipe, wherein an annular chamber defined between the main pipe and the auxiliary pipe defines one channel and an interior of the auxiliary pipe defines the other channel, and wherein a supply of treatment liquid takes place at opposite ends or adjacent ends of the channels.

13. The spray fitting of claim 10, wherein the distributing pipes on each side of the main pipe are alternatingly connected with one channel or the other channel.

14. The spray fitting of claim 10, wherein a cross section of the distributing pipes is stepped toward free ends thereof or decreases constantly.

15. The spray fitting of claim 10, wherein the distributing pipes are stepped, such that the distributing pipes have a flat side and an oppositely disposed stepped side.

16. The spray fitting of claim 15, wherein the distributing pipes are arranged with their flat sides as upper sides in the tower.

17. The spray fitting of claim 10, wherein spacings of adjacent nozzles supported by the distributing pipes are the same within the spraying plane in all directions.

18. A tower of an installation for treating of a gas flow with a liquid and comprising at least one spray fitting of claim 10.
